(19) United States
(12) Patent Application Publication
(10) Pub. No.: US 2023/0202048 A1
(43) Pub. Date: Jun. 29, 2023

(54) SYSTEMS AND METHODS FOR A STUD PLATE CONNECTOR END EFFECTOR

(71) Applicant: BotBuilt, Inc., Durham, NC (US)

(72) Inventors: Christopher Ames, Durham, NC (US); Kenneth Marenco, Durham, NC (US)

(21) Appl. No.: 18/088,201

(22) Filed: Dec. 23, 2022

Related U.S. Application Data
(60) Provisional application No. 63/293,353, filed on Dec. 23, 2021.

(51) Int. Cl. B25J 9/16; B25J 15/00

(52) U.S. Cl. CPC B25J 9/1697; B25J 15/0028; B25J 9/1669; B25J 9/1664; B25J 9/1653

(57) ABSTRACT

Systems and methods for a stud plate connector end effector are disclosed. A system includes a first clamping gripper and a second clamping gripper configured to secure a first piece of lumber during a lumber joining process. An abutting gripper located perpendicular to the first and second clamping grippers is configured to secure a second piece of lumber during the lumber joining process. One end of the second piece of lumber is positioned in contact with the first piece of lumber. A fastening tool located on an opposite end from the abutting gripper is configured to attach the first and second pieces of lumber together. A vision system is configured to align the second piece of lumber to the first piece of lumber. The first, second and abutting grippers align the first and second pieces of lumber based on an alignment data from the vision system.

### CROSS-REFERENCE TO RELATED APPLICATIONS

This application claims priority to and the benefit of U.S. Provisional Application No. 63/293,353 titled “Stud Plate Connector End Effector” and filed Dec. 23, 2021 which is incorporated herein by reference in its entirety.

### TECHNICAL FIELD

The present disclosure generally relates to systems and methods for joining and/or bonding one or more fixtures, such as stud plates, using automated mechanical means including robotic end effectors.

### BACKGROUND

Residential home and/or industrial building construction can often be dependent on slow, inefficient, rigid, expensive and manual conventional construction techniques. Some fundamental operations used in construction of a residential home and/or industrial building can be manual labor intensive and imprecise. Furthermore, conventional construction materials can be limited to specific size requirements, and can also be pre-formed offsite, and when received at the construction site, may not fit or meet the specifications required for its intended use. Additionally, conventional construction techniques that are used for forming such conventional construction materials are often performed offsite from the construction site, and are manual labor intensive. In a specific example, conventional techniques for stud plate preparation and/or connection, for forming of wall frames used in residential home, commercial, and/or industrial building construction can be a manual process, requiring a lot of human input and can produce imperfections in the final wall frame and/or construction material product.

The foregoing discussion, including the description of motivations for some embodiments of the invention, is intended to assist the reader in understanding the present disclosure, is not admitted to be prior art, and does not in any way limit the scope of any of the claims.

### SUMMARY

Systems and methods for a stud plate connector end effector are disclosed. A system comprises a first clamping gripper and a second clamping gripper. The first and second clamping grippers are configured to secure a first piece of lumber in place during a lumber joining process. An abutting gripper located perpendicular to the first and second clamping grippers. The abutting gripper is configured to secure a second piece of lumber during the lumber joining process. One end of the second piece of lumber is positioned in contact with the first piece of lumber. A fastening tool located on an opposite end from the abutting gripper. The fastening tool is configured to attach the first piece of lumber to the second piece of lumber as part of the lumber joining process. A vision system is configured to align the pieces of lumber. The first, second and abutting grippers align the first and second pieces of lumber together based on an alignment data provided by the vision system.

Various embodiments of the system can include one or more of the following features.

The vision system including a camera. The camera including a RGB+Depth camera. The vision system including at least one of an optical sensor, an ultrasonic sensor, or a lidar sensor. The vision system configured to determine at least one of a location or orientation of the first and second pieces of lumber. The system having a robotic arm and/or a motion system. The system including a control system configured to control the positioning of the first, second and/or the abutting grippers.

A method for joining lumber. The method can include positioning a first clamping gripper and a second clamping gripper over a first piece of lumber based on a deviation position of the first piece of lumber. The method can include positioning an abutting gripper over a second piece of lumber based on a deviation position of the second piece of lumber. The method can include clamping the first piece of lumber using the first and second clamping grippers and clamping the second piece of lumber using the abutting gripper. The method can include moving the abutting gripper to align the second piece of lumber to the first piece of lumber for joining the first and second pieces of lumber. The method can include aligning a fastening tool to the first piece of lumber to a fastening position for joining the first and second pieces of lumber. The method can include joining the first and second pieces of lumber together by engaging the fastening tool.

Various embodiments of the method can include one or more of the following steps.

Prior to positioning the first and second clamping grippers over the first piece of lumber, capturing a current position of the first and second pieces of lumber within a stud plate connection end effector system. Calculating the deviation position of the first and second pieces of lumber based on the current position and a target final position for joining the first and second pieces of lumber. Prior to capturing the current position of a first and second pieces of lumber, placing the first and second pieces of lumber at a target position within the stud plate connection end effector system. Capturing the current position can include using a camera to capture the current position of a first and second pieces of lumber. Capturing the current position can include using a RGB+Depth camera to capture the current position of a first and second pieces of lumber. Capturing the current position using at least one of an optical sensor, an ultrasonic sensor, or a lidar sensor to capture the current position of a first and second pieces of lumber. Moving the abutting gripper can include moving the abutting gripper along one end of the second piece of lumber to contact the first piece of lumber. Rotating a clamping axis to a target angle configured for joining the first and second pieces of lumber, the target angle calculated based on the deviation position of the first and second pieces of lumber. Joining the first and second pieces of lumber can include at least one of nailing or fastening the first piece of lumber to the second piece of lumber. Aligning the fastening tool to the first piece of lumber can include moving a sliding actuator to move the fastening tool to contact the first piece of lumber.

### BRIEF DESCRIPTION OF THE DRAWINGS

The accompanying figures, which are included as part of the present specification, illustrate the presently preferred embodiments and together with the generally description given above and the detailed description of the preferred embodiments given below serve to explain and teach the principles described herein.

FIG. 1 illustrates a plan view of a stud plate connector end effector system, according to some embodiments.

FIG. 2 illustrates a cross-sectional view of the stud plate connector end effector system, according to some embodiments.

FIG. 3 illustrates another cross-sectional view of the stud plate connector end effector system, according to some embodiments.

FIG. 4 illustrates a flowchart of an exemplary method for joining lumber, according to some embodiments.

FIG. 5 illustrates a diagram of an exemplary hardware and software systems implementing the systems and methods described herein, according to some embodiments.

While the present disclosure is subject to various modifications and alternative forms, specific embodiments thereof have been shown by way of example in the drawings and will herein be described in detail. The present disclosure should be understood to not be limited to the particular forms disclosed, but on the contrary, the intention is to cover all modifications, equivalents, and alternatives falling within the spirit and scope of the present disclosure.

### DETAILED DESCRIPTION

The present disclosure generally relates to systems and methods for automated, flexible, and/or cost-effective, creation of components for residential and/or industrial construction. Systems, processes and/or techniques are presented that provide for simplification, and/or decreasing construction time, for residential homes and/or industrial buildings. In some examples, systems and techniques for reliably and repeatably forming construction components are presented. Such components can include stud plates which are part of wall frames, and/or other construction materials, used in residential home, commercial, and/or industrial building construction applications.

An exemplary operation for forming wood-based construction materials can include joining at least two pieces of wood material such that each piece of wood and/or lumber is at a fixed angle relative to the other piece of wood. In one example, the pieces of wood, e.g., also called studs, can be positioned at an angle of approximately 90 degrees, among other angles. Conventional construction operations can be usually performed by hand, or by applying fixtures which are incorporated into a work table to hold the wood at a fixed angle relative to each piece of wood. Such fixtures can be rigidly attached to the work table while the operational tool can move around, which can limit the locations that the wood and/or lumber can be clamped for accurate stud formation. Further, such features may not have means by which to know whether a piece of the wood is within a target tolerance for stud plate connection, or whether the wood has been accurately placed for the stud plate formation.

In some embodiments, systems and method for a stud plate connector and end effector are presented herein to address the above challenges. The stud plate connector and end effector system can be configured to reduce human input and/or control for processing lumber. As used herein, the stud plate connector and stud plate connector and end effector system can be configured to receive lumber, wood, treated wood, wood panels, and/or any type of wood which can be used for residential, commercial and/or industrial construction applications. Similarly, as used herein, the term lumber and/or lumber can be used to refer to wood, treated wood, wood panels, and/or any type of wood which can be used for residential, commercial and/or industrial construction applications. In some examples, the terms lumber, wood, treated wood, wood panel, as used herein can be used interchangeably. Similarly, as described herein, lumber, wood, treated wood, wood panels, and/or any type of wood can refer to a single piece of lumber and/or wood, or multiple pieces of lumber and/or wood.

### Stud Plate Connector End Effector System

A stud plate connector end effector system is presented. In some embodiments, the stud plate connector end effector system can include components configured for joining lumber. In some examples, the stud plate connector end effector system can include gripper actuators mounted on a rotating actuator. As referred to herein, the gripping actuators can be referred to as clamping actuators, among other terms. The stud plate connector end effector system can include an abutting gripper actuator which can be mounted on a sliding actuator. The stud plate connector end effector system can include a fastening tool, and/or a vision system. The vision system can include a camera and/or a depth sensor. The camera can include the depth sensor, or the camera can be separate from the depth sensor. In one example, the camera and/or depth sensor can include a RGB+Depth sensor, e.g., a sensor configured to generate an RGB+Depth type data, as further described below. As used herein, RGB+Depth can also be referred to as a RGB+D, e.g., to refer to a RGB+D camera and/or RGB+D sensor. As used herein, the camera can refer to a visual sensor, depth sensor, detector, and/or any other type of sensor configured to determined, provide, detect, and/or collect data on spatial and/or temporal data of an object.

In some embodiments, the stud plate connector end effector system can be configured for joining stud joints, e.g., joining at least two pieces of lumber together, by clamping, fastening, and/or using a vision system included as part of the stud plate connector end effector system. In one example, the stud plate connector end effector system can be configured to position one piece of lumber at an angle of approximately 90 degrees to another piece of lumber. In some examples, the joining of lumber can be performed by clamping, fastening, and/or using the vision system as part of a single end effector. The stud plate connector end effector system can be configured to be movable, e.g., can be configured to be movable to 6 degrees of freedom (6-DOF) or configured to be movable to more than 6 DOF. In some examples, the stud plate connector end effector system can include a robot arm. The robot arm can be configured to move the stud plate connector and effector system in up to 6 degrees of freedom. In some examples, the stud plate connector end effector system can be configured for clamping and/or, fastening and include a vision system. As used herein, the vision system can also be referred to as a perception system, among other terms. The stud plate connector end effector system can be configured for forming stud plates and/or stud joints together, e.g., such as forming stud joints by accurately and/or precisely joining at least two pieces of lumber together. As used herein, the stud plate joint can also be referred to as a joint, among other terms. The stud plate connector end effector system can be configured to inspect the completed stud plate joint. In some examples, the stud plate connector end effector system can be configured to form the stud plate joint and inspect the completed joint without performing a tool change operation. The stud plate connector end effector system can be configured to perform clamping and/or fastening operations at any location within the reach of a motion controller and/or a motion system of the stud plate connector end effector system. The motion system can include one or more underlying mechanisms configured to move the stud plate connector. In some examples, the motion system can include a robot arm, a gantry, and/or mobile robot system. The motion system can be attached to the tool changer. The motion system can move with the stud plate connector end effector system. The stud plate joints can be formed at having a target angle, e.g., the joints can be formed having an approximately 90 degree angle between connected pieces of lumber. The stud plate connector end effector system can include a clamping mechanism which can be configured to be guided around, and/or to grasp, a piece of lumber. The stud plate connector end effector system can be configured to inspect one or more positions, e.g., all positions, for fastening pieces of lumber together, and to determine a target position to join the pieces of lumber together. The target position to join the pieces of lumber together can include a target position that provides for the most stable connection, and/or a position that allows for the fastest operation for joining the pieces of lumber together.

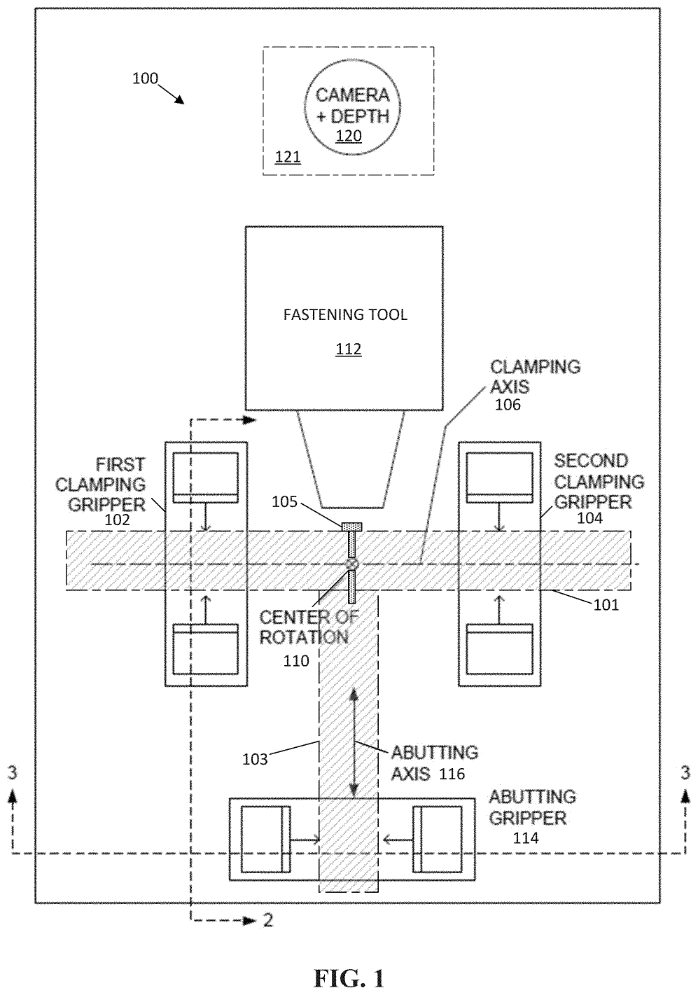

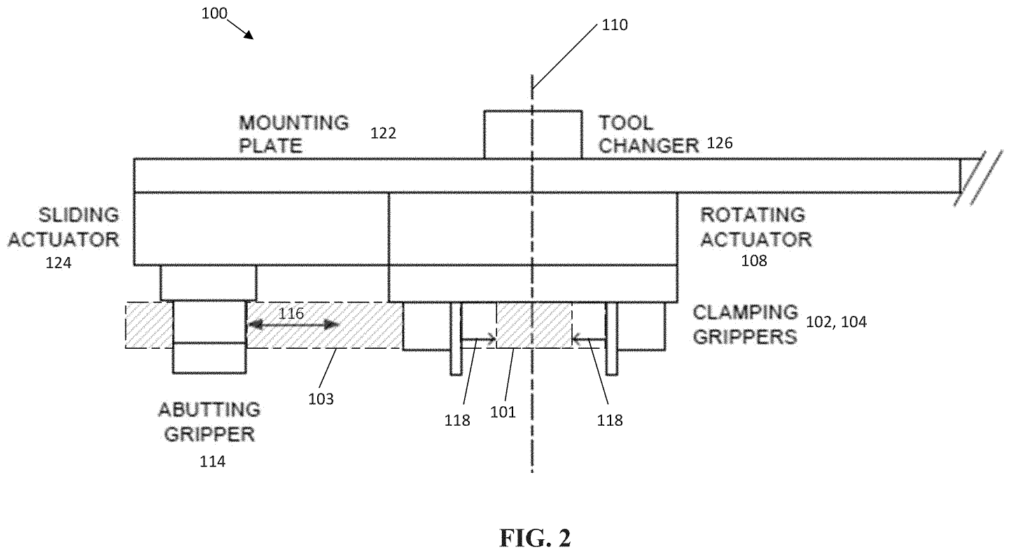

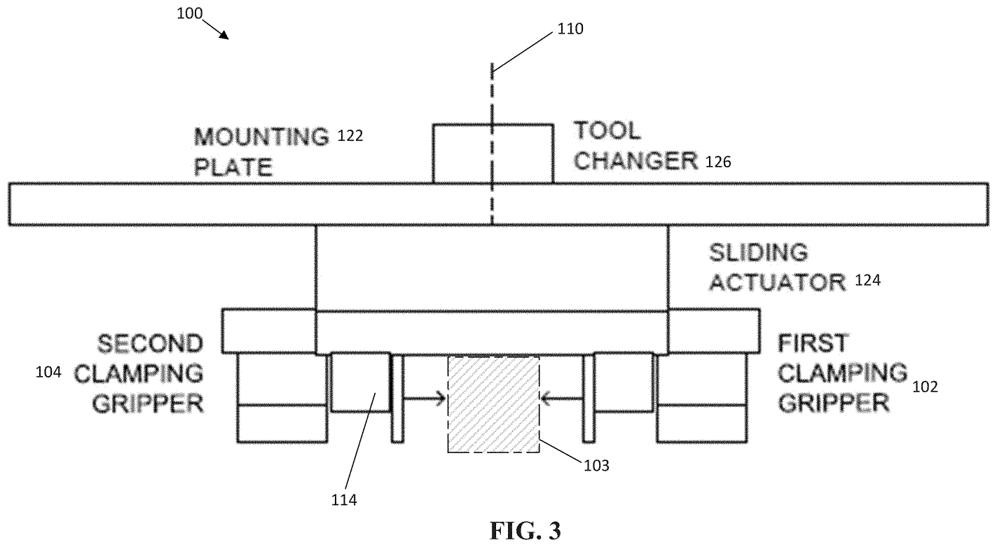

Referring to FIGS. 1-3, various views of a stud plate connector end effector system is shown, according to some embodiments. In some embodiments, the stud plate connector end effector system 100 can include a first clamping gripper 102 and second clamping gripper 104 disposed such that a center of each gripper 102, 104 is aligned to a clamping axis 106. In some examples, the first and second clamping grippers 102, 104 can be configured to secure one or more pieces of lumber during a lumber joining process. As shown in FIGS. 1 and 2, the first and second clamping grippers 102, 104 can be configured to secure a first piece of lumber 101. As referred to herein, the clamping grippers 102, 104, can also be referred to as grippers, among other terms. In some examples, the gripper's 102, 104 can include gripping fingers, and the gripping fingers can be aligned on lines parallel to the clamping axis 106. The first and second clamping grippers 102, 104 can be mounted on a rotating actuator 108. The grippers 102, 104 can be spaced apart equidistant from an axis of rotation 110 of the rotating actuator 108. The axis of rotation 110 can be configured to allow the stud plate connector end effector system 100 to handle a continuous set of angles with respect to one or more pieces of lumber being joined.

In some embodiments, the stud plate connector end effector system can include an abutting gripper 114. In some examples, the abutting gripper 114 can be located perpendicular to the first and second clamping grippers 102, 104. The abutting gripper 114 can be configured to secure a second piece of lumber 103 during the lumber joining process. In one example, one end of the second piece of lumber 103 can be positioned in contact with the first piece of lumber 101. In one example, the first and second clamping grippers 102, 104 and the abutting gripper 114 can be configured to position the first piece of lumber 101 at an angle in a range of approximately 45-90 degrees to the second piece of lumber 103. In the same example, the rotating actuator 108 can be configured to allow the clamping grippers 102, 104 to change an angle of the first piece of lumber 101 held by the clamping grippers 102, 104, with respect to the second piece of lumber 103 held by the abutting gripper 114, e.g., the angle can include the angle between the first and second pieces of lumber 101, 103.

The stud plate connector and end effector system 100 can include a fastening tool 112 disposed on an opposite end from the abutting gripper 114, and adjacent to the clamping grippers 102, 104. The fastening tool 112 can be aligned and/or configured to discharge nails and/or fasteners 105 towards a center of the clamping axis 106, i.e., towards the axis of rotation 110. In some examples, the fastening tool 112 can include a nail gun. In one example, the fastening tool 112 can be configured to discharge fasteners 105 into the second piece of lumber 103 located at center of the clamping axis 106 between the first and second clamping grippers 102, 104.

In some embodiments, the stud plate connector end effector system 100 can include a vision system 119 for detecting and/or capturing a position and/or location of one or more pieces of lumber. In some examples, the vision system 119 can be configured to align the second piece of lumber 103 to the first piece of lumber 101, wherein the first, second and abutting grippers 102, 104, 114 can align the first and second pieces of lumber 102, 104 together based on an alignment data provided by the vision system 119. The vision system can include an optical sensor, an ultrasonic sensor, and/or a lidar sensor. In one example, the vision system can include a camera 120. The camera 120 can include a RGB+Depth camera. The camera 120 can be configured to be positioned in a fixed relationship to the axis of rotation 110, and to the abutting axis 116. The movement system (e.g., robot) can be configured to position the camera 120 to view lumber located in storage areas. The movement system (e.g., robot) can be configured to position the camera 120 to view one or more lumber 101, 103 as shown, e.g., to allow the vision system 119 and/or camera 120 determine position information of the pieces of lumber 101, 103. In some examples, alignment data can include position information of the pieces of lumber 101, 103. In some examples, the position information of the pieces of lumber can include the size, location, orientation, of the pieces of lumber, among other information. The position information of the pieces of lumber can be translated to one or more different reference frames, e.g., translated to an inertial, e.g., a fixed, reference frame. The position information of the pieces of lumber can be translated to a dynamic reference frame, e.g., from the perspective of the end effector. In some embodiments, the robot can be configured to pick-up and/or place the lumber to a target position and/or location, e.g., for joining and/or storage, based on the translated position information. In some examples, the visions system 119 can be configured to determine a relative to a position of the camera 120 and/or with respect to the pieces of lumber 101, 103.

In some embodiments, the camera 120 can include a RGB+Depth camera. In some examples, the camera 120 can include one or more depth sensors configured to project light and/or radiation, e.g., optical, radar, lidar, among others, and detect returning light and/or radiation scattered by interaction of the light and/or radiation with objects within an imaging field of the camera 120. The camera 120 can be configured to determine information of the objects within the imaging field. The camera 120 can be configured to perform depth calculations of the imaging field, and/or objects within the imaging field. The depth calculations can be based on geometry, time of flight, among other data and/or techniques used to determine a distance from the camera (e.g., camera sensor) to various points on objects within the imaging field. Although one camera is described herein, more than one camera 120 can be used, e.g., the vision system 119 can include and/or use 1, 2, 3 or more cameras. The 1, 2, 3 or more cameras can also be referred to herein as a plurality of cameras, each of the plurality of cameras can be the same and/or similar to the camera 120. In some examples, the determined information can be collected, processed, and/or, translated to a target frame of reference for use by a motion controller of the stud plate connector end effector system 100. In one example, the stud plate connector end effector system 100 can include a robot control system, and the motion system and/or motion controller can be included and/or be part of, the robot control system. In some examples, the control system can be configured to control the positioning of the first, second and abutting grippers 102, 104, 114 during the lumber joining process.

In some embodiments, the stud plate connector end effector system 100 can be configured to use computational models, e.g., such machine learning models and/or techniques for determining, depth, distance, position, movement, location, among other information used for joining lumber together. In some examples, the camera, and/or any other type of sensor of the stud plate connector end effector system 100 can be configured to use computational models, e.g., such machine learning models and/or techniques. The computations models and/or techniques can be embedded within the camera, sensor and/or associated data processors of the camera and/or sensor. As described herein, one or more cameras and/or sensors can be used. In an example, multiple RGB+Depth cameras and/or sensors can be used and/or deployed as part of the stud plate connector end effector system. In an example, multiple RGB+Depth cameras and/or sensors can be used and/or deployed in and around the motion system, and sensor fusion techniques may be employed to combine their outputs, to generate a comprehensive picture of the imaging field. In some examples, the stud plate connector end effector system 100 can use software in combination with the hardware components described herein, e.g., the components shown in FIGS. 1-5 to performing the joining methods. In one example, the software used by the stud plate connector end effector system 100 can include the computational models described above.

In some embodiments, the stud plate connector end effector system 100 can include a mounting plate 122, sliding actuator 124, and a tool changer 126. The abutting gripper 114 can be mounted and/or attached to the sliding actuator 124. The sliding actuator 124 can be mounted and/or attached to mounting plate 122. As described above, the grippers 102, 104 can be mounted and/or attached to the rotating actuator 108. Similar to the sliding actuator 124, the rotating actuator 108 can be mounted and/or attached to mounting plate 122. The mounting plate 122 can include aluminum and/or steel mounting plate. The sliding actuator 114 can be configured to move and/or slide on the sliding actuator 124, along the abutting axis 116, and towards the grippers 102, 104. The tool changer 126 can be used to attach and/or detach the stud plate connector end effector system 100 from the motion system, e.g., the motion system and/or motion controller of a robot arm and/or the robot control system. The tool changer 126 can be used to attach and/or mount one or more tools, e.g., such as the fastening tool 112.

### Methods for Joining Lumber

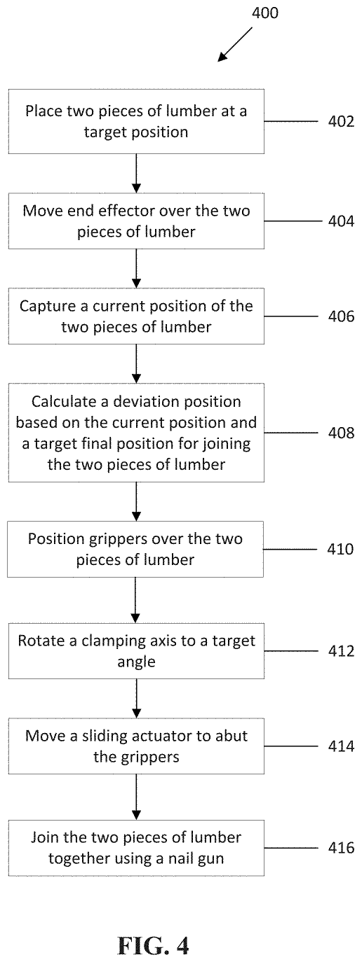

Referring to FIG. 4, a flowchart 400 of an exemplary method for joining lumber is shown, according to some embodiments. In a step 402, two pieces of lumber are placed at a target position, e.g., within about 5 inches from one another. As described herein, the two pieces of lumber can be referred to individually as a first piece of lumber and a second piece of lumber. In a step 404, an end effector is moved over the two pieces of lumber. In a step 406, a current position of the two pieces of lumber is determined and/or captured, e.g., using a camera. In a step 408, a deviation position is calculated based on the current position, and based a target final position for joining the two pieces of lumber. In a step 410, grippers are positioned over the two pieces of lumber, and the clamps of the grippers are actuated to clamp onto each of the two pieces of lumber. In a step 412, a clamping axis is rotated to a target angle, e.g., using an actuator. The target angle can be calculated based on the current position, deviation position and/or the target final position of the two pieces of lumber. In a step 414, a sliding actuator is moved to contact the grippers, e.g., along an abutting axis and towards an axis of rotation, until one end of the second piece of lumber abuts another end of the first piece of lumber, e.g., located between a clamping position of the grippers. The sliding actuator is moved to press the second piece of lumber tightly against a face of the first piece of lumber. Pressing the second piece of lumber tightly against the face of the first piece of lumber can allow and/or ensure target tolerances are achieved, and/or to absorb fastening forces between the two pieces of lumber. In a step 416, the two pieces of lumber together can be joined together and/or attached, e.g., using a fastening tool, such as a nail gun. In one example, the joining and/or attaching can include using the fastening tool to drive fasteners through the first piece of lumber, and into the second piece of lumber, joining the two pieces of lumber together. In some examples, the rotation of the clamping axis, and/or the positioning of the abutting axis in alignment with the fastening tool, allows the fasteners to align along a center of the second piece of lumber, regardless of an angle and/or position of the clamping axis.

### Advantages for the Stud Plate Connector End Effector System

In some embodiments, the stud plate connector end effector system can be configured to combine clamping, fastening, and/or object detection to allow for precise and/or accurate stud joint formation. In some examples, the stud plate connector end effector system can be flexible and reliable in comparison to other construction systems. In one example, the flexibility of the system can be provided by the vision system of the stud plate connector end effector system. The vision system can be configured to detect and/or localize the lumber that are being joined. the localization information used by the stud plate connector end effector system in the joining process can allow the clamping mechanism, e.g., grippers, to be substantially reduced in size as compared to conventional grippers, and configurable to handle a target tolerance of uncertainty in the positioning of the lumber. In addition, the vision system can be configured to allow for the stud joint to be checked after completion and/or formation. A rotating clamping axis and fixed abutment axis can be used as a reference for the formation of stud joints at any target angle, e.g., including using fasteners aligned along a center of abutting lumber. In some examples, packaging of these functions together can allow fastening and/or clamping to become location independent.

### Hardware and Software Implementations

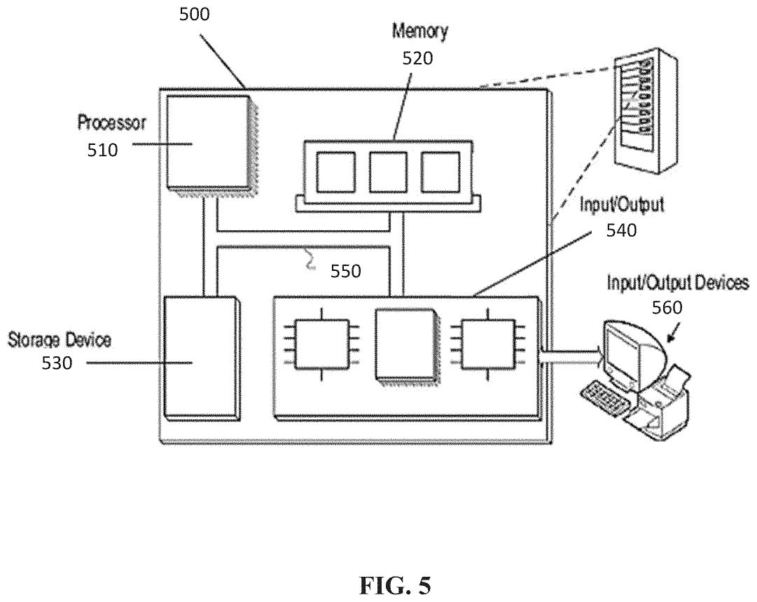

FIG. 5 is a block diagram of an example computer system 500 that may be used in implementing the technology described in this document. General-purpose computers, network appliances, mobile devices, or other electronic systems may also include at least portions of the system 500. The system 500 includes a processor 510, a memory 520, a storage device 530, and an input/output device 540. Each of the components 510, 520, 530, and 540 may be interconnected, for example, using a system bus 550. The processor 510 is capable of processing instructions for execution within the system 500. In some implementations, the processor 510 is a single-threaded processor. In some implementations, the processor 510 is a multi-threaded processor. The processor 510 is capable of processing instructions stored in the memory 520 or on the storage device 530.

The memory 520 stores information within the system 500. In some implementations, the memory 520 is a non-transitory computer-readable medium. In some implementations, the memory 520 is a volatile memory unit. In some implementations, the memory 520 is a non-volatile memory unit.

The storage device 530 is capable of providing mass storage for the system 500. In some implementations, the storage device 530 is a non-transitory computer-readable medium. In various different implementations, the storage device 530 may include, for example, a hard disk device, an optical disk device, a solid-date drive, a flash drive, or some other large capacity storage device. For example, the storage device may store long-term data (e.g., database data, file system data, etc.). The input/output device 540 provides input/output operations for the system 500. In some implementations, the input/output device 540 may include one or more of a network interface devices, e.g., an Ethernet card, a serial communication device, e.g., an RS-232 port, and/or a wireless interface device, e.g., an 802.11 card, a 3G wireless modem, or a 4G wireless modem. In some implementations, the input/output device may include driver devices configured to receive input data and send output data to other input/output devices, e.g., keyboard, printer and display devices 560. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 530 may be implemented in a distributed way over a network, for example as a server farm or a set of widely distributed servers, or may be implemented in a single computing device.

Although an example processing system has been described in FIG. 5, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array) or an ASIC (application specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; and magneto optical disks. The processor and the memory can be supplemented by, or incorporated in, special purpose logic circuitry.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

### Terminology

The phraseology and terminology used herein is for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of” “only one of” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A system comprising:
a first clamping gripper and a second clamping gripper, wherein the first and second clamping grippers are configured to secure a first piece of lumber in place during a lumber joining process;
an abutting gripper located perpendicular to the first and second clamping grippers, the abutting gripper configured to secure a second piece of lumber during the lumber joining process, wherein one end of the second piece of lumber is positioned in contact with the first piece of lumber;
a fastening tool located on an opposite end from the abutting gripper, wherein the fastening tool is configured to attach the first piece of lumber to the second piece of lumber as part of the lumber joining process; and
a vision system configured to align the second piece of lumber to the first piece of lumber, wherein the first, second and abutting grippers align the first and second pieces of lumber together based on an alignment data provided by the vision system.

2. The system of claim 1, wherein the fastening tool is configured to discharge fasteners into the first and second piece of lumber located at center of a clamping axis between the first and second clamping grippers.

3. The system of claim 1, wherein the vision system includes a camera.

4. The system of claim 1, wherein the vision system includes a RGB+Depth camera.

5. The system of claim 1, wherein the vision system comprises at least one of an optical sensor, an ultrasonic sensor, or a lidar sensor.

6. The system of claim 1, wherein the vision system is configured to determine at least one of a location or orientation of the first and second pieces of lumber.

7. The system of claim 1 further comprising a motion system.

8. The system of claim 7, wherein the motion system comprises at least one of a robotic arm, or a gantry.

9. The system of claim 1, further comprising a control system configured to control the positioning of the first, second and abutting grippers.

10. A method for joining lumber, comprising:
positioning a first clamping gripper and a second clamping gripper over a first piece of lumber based on a deviation position of the first piece of lumber;
positioning an abutting gripper over a second piece of lumber based on a deviation position of the second piece of lumber;
clamping the first piece of lumber using the first and second clamping grippers and clamping the second piece of lumber using the abutting gripper;
moving the abutting gripper to align the second piece of lumber to the first piece of lumber for joining the first and second pieces of lumber;
aligning a fastening tool to the first piece of lumber to a fastening position for joining the first and second pieces of lumber; and
joining the first and second pieces of lumber together by engaging the fastening tool.

11. The method of claim 10, wherein prior to positioning the first and second clamping grippers over the first piece of lumber, capturing a current position of the first and second pieces of lumber within a stud plate connection end effector system.

12. The method of claim 11, further comprising calculating the deviation position of the first and second pieces of lumber based on the current position and a target final position for joining the first and second pieces of lumber.

13. The method of claim 11, wherein prior to capturing the current position of a first and second pieces of lumber, placing the first and second pieces of lumber at a target position within the stud plate connection end effector system.

14. The method of claim 11, wherein capturing the current position comprises using a camera to capture the current position of a first and second pieces of lumber.

15. The method of claim 11, wherein capturing the current position comprises using a RGB+Depth camera to capture the current position of a first and second pieces of lumber.

16. The method of claim 11, wherein capturing the current position using at least one of an optical sensor, an ultrasonic sensor, or a lidar sensor to capture the current position of a first and second pieces of lumber.

17. The method of claim 10, wherein moving the abutting gripper comprises moving the abutting gripper along one end of the second piece of lumber to contact the first piece of lumber.

18. The method of claim 10, further comprising rotating a clamping axis to a target angle configured for joining the first and second pieces of lumber, the target angle calculated based on the deviation position of the first and second pieces of lumber.

19. The method of claim 10, wherein joining the first and second pieces of lumber comprises at least one of nailing or fastening the first piece of lumber to the second piece of lumber.

20. The method of claim 10, wherein aligning the fastening tool to the first piece of lumber comprises moving a sliding actuator to move the fastening tool to contact the first piece of lumber.
